(19) United States
(12) Patent Application Publication
(10) Pub. No.: US 2006/0020488 A1
(43) Pub. Date: Jan. 26, 2006

(54) Methods and systems for providing and managing novelty deeds or fractional interests in property

(75) Inventor: Brent Hickey, Phoenix, AZ (US)

Correspondence Address: PERKINS COIE LLP;PATENT-SEA, P.O. BOX 1247, SEATTLE, WA, 98111-1247, US

(73) Assignee: PFP LLC

(21) Appl. No.: 11/226,160

(22) Filed: Sep. 14, 2005

Related U.S. Application Data
(63) Continuation-in-part of application No. 10/897,218, filed on Jul. 22, 2004.

(51) Int. Cl. G06Q 99/00

(52) U.S. Cl. 705/1

(57) ABSTRACT

Methods and systems for managing novelty deeds are disclosed. One aspect of the invention is directed toward a method for generating income for a famous property that includes dividing the property into multiple interests, creating a novelty deed for each of the interests, and selling the novelty deeds to consumers. In certain embodiments, the novelty deeds can be valid for a predetermined time and invalid after the predetermined time has expired. Another aspect of the invention is directed toward a computer-implemented method for creating and managing novelty deeds that includes identifying multiple interests of a famous property, creating a novelty deed for each one of the multiple interests, and tracking the sale of the novelty deeds. The novelty deeds can be sold for a predetermined amount of money and/or can be valid for a predetermined time and invalid after the predetermined time has expired.

### CROSS REFERENCE TO RELATED APPLICATIONS

The present application is a continuation-in-part application of U.S. patent application Ser. No. 10/897,218 filed on Jul. 22, 2004, entitled A METHOD FOR OFFERING DEEDS TO FAMOUS LOCATIONS, the entirety of which is incorporated herein by reference.

### BACKGROUND

Governmental authorities, as well as for-profit and nonprofit entities, have always had a difficult time in raising revenues without increasing taxes or increasing charges or fees for different goods or services that are provided. Presently, many of these governmental authorities and other entities are operating at a shortfall with expenditures exceeding income.

When attending various events (e.g., a car race) or visiting various places (e.g., national parks, monuments, land marks, stadiums), many people like to buy souvenirs. These souvenirs can include tee-shirts, coffee mugs, and/or magnets that have an associated picture or name printed thereon. While these items are nice, they have become common place and lack real novelty or uniqueness. Furthermore, very little of the money spent on these souvenirs actually goes back to the governmental authorities or other entities that own or control the events or sites so that the entity can continue to provide services and maintenance at the sites.

Information regarding many of these events or sites can be accessed by computer, and in some cases souvenirs can be purchased via computer. Computers have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like.

### BRIEF DESCRIPTION OF THE DRAWINGS

FIG. 1 is flow chart illustrating a method for managing novelty deeds in accordance with embodiments of the invention.

FIG. 2 is a block diagram of a basic and suitable computer that may employ aspects of the invention.

FIG. 3A is a block diagram illustrating a simple, yet suitable system in which aspects of the invention may operate in a networked computer environment.

FIG. 3B is a block diagram illustrating an alternative system to that of FIG. 2A.

FIG. 4 is a flow chart illustrating a computer implemented method for managing novelty deeds in accordance with embodiments of the invention.

FIG. 5 is a schematic illustration of a computer screen in a computing environment used to manage novelty deeds in accordance with certain embodiments of the invention.

FIG. 6 is a schematic illustration of a computer screen in a computing environment used to manage novelty deeds in accordance with other embodiments of the invention.

FIG. 7 is a schematic illustration of a computer screen in a computing environment used to manage novelty deeds in accordance with still other embodiments of the invention.

FIG. 8 is a schematic illustration of a computer screen in a computing environment used to manage novelty deeds in accordance with yet other embodiments of the invention.

FIG. 9 is a schematic illustration of a tangible document representing a novelty deeds in accordance with embodiments of the invention.

Note: the headings provided herein are for convenience and do not necessarily affect the scope or interpretation of the invention.

### DETAILED DESCRIPTION

Aspects of the present invention are directed generally toward creating and managing novelty deeds, including a data processing system for managing rights, where the system includes means for defining fractional interests in a property. The means for defining obtains data associated with a division of the property and the data associated with the division corresponds to surveying or mapping the property to divide the property into multiple interests. The system further includes means for creating a novelty deed for each of the interests and means for distributing the novelty deeds to individual entities for a predetermined amount of money as a souvenir of the property.

Other aspects of the invention are directed toward a method for generating income for a famous property that includes dividing the famous property into multiple interests. The famous property can be located on or in the earth. The method can further include creating a novelty deed for each of the interests, selling novelty deeds to consumers, and creating a tangible novelty deed document corresponding to each novelty deed sold. The method can still further include distributing the tangible novelty deed documents to the corresponding consumers.

Still other aspects of the invention are directed toward a method for generating income for a famous property that includes dividing the famous property into multiple interests. The famous property can be located on or in the earth. The method can further include creating a novelty deed for each of the interests and selling the novelty deeds to consumers. The novelty deeds can be valid for a predetermined time and invalid after the predetermined time has expired.

Yet other aspects of the invention are directed toward a computer readable medium having a data structure associated with fractional interests in property where the data structure includes a first data portion identifying one of multiple interests of a property. The first data portion can be associated with a deed for the one interest. The deed conveys no legal interest in the property, or conveys at least one right, but no legal liability associated with the property. The first data portion can include additional information associated with the property. The data structure can include a second data portion for tracking sale or resale of the deed associated with the one interest in the property. The deed can be at least initially associated with a predetermined amount of money. The second data structure can include information associated with at least one current or previous owner of the deed associated with the one interest in the property.

Still other aspects of the invention are directed toward a system for creating and managing novelty deeds that includes means for identifying multiple interests of a famous property. The famous property can be located on or in the earth. The system can further include means for creating a novelty deed for each one of the multiple interests and means for tracking sales of the novelty deeds to consumers. Tracking the sales of novelty deeds can include at least one of tracking a transfer of money associated with the sales and tracking ownership of the novelty deeds.

Yet other aspects of the invention are directed toward a computer readable medium having computer-executable instructions for performing a method that includes identifying multiple interests of a famous property. The famous property can be located on or in the earth. The method can further include creating a novelty deed for each one of the multiple interests and tracking sales of the novelty deeds to consumers. Tracking the sales of novelty deeds can include at least one of tracking a transfer of money associated with the sales and tracking ownership of the novelty deeds.

Various embodiments of the invention will now be described, including various aspects of managing novelty deeds and managing novelty deeds in a computing environment. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

A. Creating and Managing Novelty Deeds

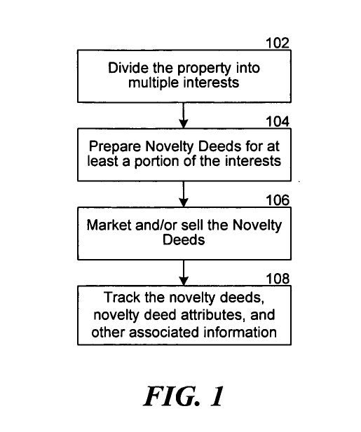

FIG. 1 illustrates a process or method 100 for managing novelty deeds. For example, the management of novelty deeds can include, among other things, the marketing of novelty deeds, offering novelty deeds for sale, selling novelty deeds, tracking the ownership of novelty deeds, tracking the validity and/or expiration of novelty deeds, tracking the transfer of novelty deed ownership, recording the sale of novelty deeds, tracking the recordation of novelty deeds, and/or repurchasing or renewing novelty deeds. This process can allow owners or potential owners of property (e.g., famous property) to generate income by selling novelty deeds. In certain embodiments, this income can be used to perform maintenance and upkeep of the property, for the benefit of the owner, and/or for the benefit of the public. Accordingly, in some circumstances this income can allow the owner to perform maintenance and/or make improvements to the property without having to raise admission/use fees, or in the case where the owner is a government agency without collecting additional taxes.

As used herein, the term property can include real property and/or personal property (including fixtures, heirlooms, and estates) and can be tangible or intangible. For example, property can include a race car, a ship, a race horse, an organization (e.g., the National Association for Stock Car Auto Racing, Inc.), a landmark, and/or a land site. The property can be unimproved or improved. For example a land site can include unimproved sites such as the Grand Canyon, Old Faithful, Waikiki Beach, or improved sites like the Walk of Stars in Hollywood, a portion of the Vegas Strip, a landmark on the Vegas Strip (e.g., a casino or strip club), Wrigley Field, Yankee Stadium, or the Empire State Building. The novelty deed represents an interest in the property (e.g., the novelty deed can represent a deed, license, lease, land patent, estate, right(s) or privilege(s) associated with the property, or other interest in the property). The property can include famous property and can be located on land or sea of earth or in the land or sea of the earth. For example, the property can include an underwater statue of Christ in Pennekamp State Park off the Florida keys or Pikes Peak in the Rocky Mountains of North America. As discussed below in further detail, the novelty deed may or may not convey actual ownership of the interest and may have various associated restrictions and/or releases.

In the illustrated embodiment, the property can be divided into multiple interests (block 102). The interests can include small parcels, units, estates, or the like. For example, the property may be divided into sections 1″×1″, 1′×1′, or the like. The dimensions given above are given as an example and should not be seen as to limit the scope of the present invention. A survey, map, or other description of the property may be used to define the actual location or description of each interest identified. Additionally, the property may be separated into undivided 1/10,000 interest, 1/100,000 interest, or the like. Again, the percent interest is given as an example and should not be seen as to limit the scope of the present invention. As described below, a computer system can automatically divide a given property into equal portions and assign unique numbers or definitions for each.

Novelty deeds, for at least a portion of the interests, can then be prepared (block 104). For example, the computing system described below can automatically create novelty deeds, and in certain embodiments the computing system can print tangible documents representing the novelty deeds (e.g., the novelty deeds themselves or certificates representing the novelty deeds). The novelty deeds can then be marketed and/or sold to various individuals or entities (block 106). The novelty deeds can be used as gifts, souvenirs, etc. In certain embodiments, the novelty deeds can be sold for a certain dollar amount (e.g., a predetermined dollar amount). In other embodiments, the novelty deeds can expire after a set amount of time (e.g., the novelty deeds can be valid for six months, one year, or more). When novelty deeds expire after a fixed period of time, the owner of the property can continue to raise money by renewing and/or reselling the novelty deeds.

As discussed above, in certain embodiments a novelty deed does not convey an actual ownership right. For example, language can be written in the novelty deed to let the purchaser know that they have no actual “ownership” rights to the property. Although no ownership rights are transferred, in certain situations the person or entity buying the novelty deed can be given certain privilege(s) or right(s) with regard to the property (e.g., free admission to a park). Furthermore, certain legal language may be written on the novelty deed to prevent the purchaser from trying to hinder the owner from showing/using the property. Additionally, the novelty deed can include language releasing the purchaser from certain liabilities associated with the property.

In other embodiments, the novelty deed conveys at least some actual ownership rights to the purchaser. Even though at least some ownership rights are conveyed, in certain embodiments the novelty deed can include various limitations and/or releases associated with this ownership. For example, the novelty deed can include language to prevent the purchaser from trying to hinder the owner from showing/using the property. The novelty deed can also include language to prevent the purchaser from selling or leasing the property; conveying, deeding, encumbering or transferring the interest; and/or from trying to exercise other legal rights with respect to their ownership interests. Additionally, the novelty deed can include language releasing the purchaser from certain liabilities associated with the property, e.g., taxes, personal injury liability, environmental protection liability, etc.

The money raised or received from the sale of the novelty deeds can be used in a variety of ways. For example, a portion of the money raised can be used to maintain and/or improve the associated property. For example, a portion of the money raised can be used to improve an unimproved land area or site (e.g., creating a park or constructing a building). In other embodiments, a portion of the money can be used to provide other improvements or benefits for the owner and/or the public (e.g., providing enhanced recreational benefits). Additionally, a portion of the money can be used to maintain the property (e.g., performing repairs, preserving the property, and/or keeping the property in a useable condition), for charitable purposes, or for other purpose at the direction of the owner. For example, a portion of the money can be used to offset the expenses associated with the management of novelty deeds and/or to generate revenue for the owner. In certain embodiments, novelty deeds can be sold in advanced and a portion of the revenue generated by their sale can be used to purchase the associated property.

In further embodiments, the novelty deeds, novelty deed attributes, and other information associated with the novelty deeds can be tracked, for example, by using a database or other tracking system (block 108). For example, in certain embodiments a system can be used to track the marketing of the novelty deeds (e.g., how the novelty deeds have been marketed and/or to which entities), the selling price of the novelty deeds, offers for sale that have been made, current pricing, and/or who has bid on a novelty deed. Additionally, in certain embodiments the ownership of novelty deeds can be tracked, including the identity of the buyer, ownership transfers, and the expiration of novelty deeds. In still other embodiments, the ownership of novelty deeds can be recorded with an appropriate agency (e.g., with a state agency that legally records ownership), and a system or database can be used to track recordation of the novelty deeds. In selected embodiments, a fee can be charged for recording or having the novelty deed recorded. In yet other embodiments, the use of a portion of the money received from the sale of the novelty deeds can be tracked. For example, whether a portion of the money received from the sale of novelty deeds was used for managing the novelty deeds, acquiring the property, maintaining the property, improving the property, and/or for a charitable purpose can be tracked.

B. Creating and Managing Novelty Deeds in a Computing Environment

The creation and management of novelty deeds can be facilitated by the use of a computer. For example, the creation and management of novelty deeds can include, among other things, the marketing of novelty deeds, offering novelty deeds for sale, selling novelty deeds, tracking the ownership of novelty deeds, tracking the validity and/or expiration of novelty deeds, tracking the transfer of novelty deed ownership, recording the sale of novelty deeds, tracking the recordation of novelty deeds, and/or repurchasing or renewing novelty deeds. An exemplary computing system suitable for managing novelty deeds will be discussed and then various embodiments of managing novelty deeds in a computing system will be described.

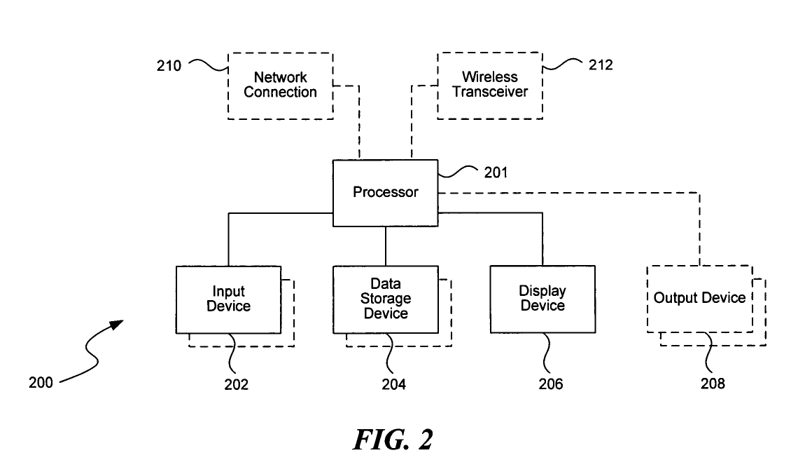

FIG. 2 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 2, one embodiment of the invention employs a computer 200, such as a personal computer or workstation, having one or more processors 201 coupled to one or more user input devices 202 and data storage devices 204. The computer is also coupled to at least one output device such as a display device 206 and one or more optional additional output devices 208 (e.g., printer, plotter, speakers, tactile or olfactory output devices, etc.). The computer may be coupled to external computers, such as via an optional network connection 220, a wireless transceiver 212, or both.

The input devices 202 may include a keyboard and/or a pointing device such as a mouse. Other input devices are possible such as a microphone, joystick, pen, game pad, scanner, digital camera, video camera, and the like. The data storage devices 204 may include any type of computer-readable media that can store data accessible by the computer 200, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 2).

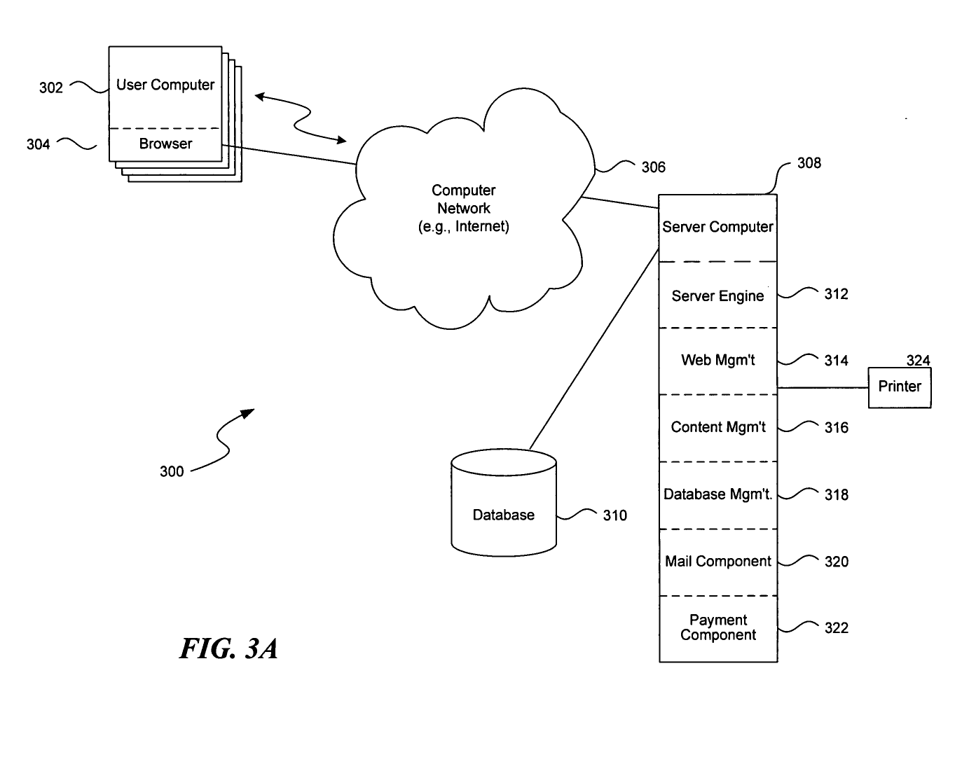

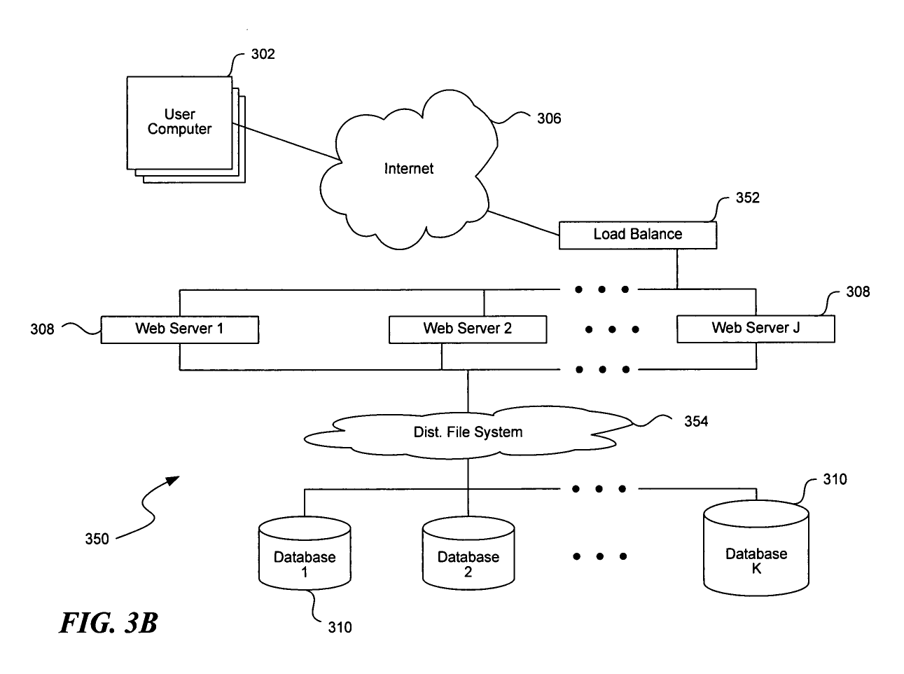

Aspects of the invention may be practiced in a variety of other computing environments. For example, referring to FIG. 3A, a distributed computing environment with a web interface includes one or more user computers 302 in a system 300 are shown, each of which includes a browser program module 304 that permits the computer to access and exchange data with the Internet 306, including web sites within the World Wide Web portion of the Internet. Alternatively, the network 306 may be any other public or private network or networks. The user computers may be substantially similar to the computer described above with respect to FIG. 2. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 308, coupled to the Internet or World Wide Web (“Web”) 306, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 310 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 308 may include a server engine 312, a web page management component 314, a content management component 316, a database management component 318, a mail component 320, and a payment component 322. Other computer related components can be connected to the server computer 308. For example, in the illustrated embodiment, a printer 324 is connected to the server computer 308. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as property descriptions, graphics, and messages. The mailing component handles emails and/or common carrier mailings (e.g., mail merging data to create mass mailers). The payment component handles payment transactions (e.g., credits and debits). For example, the payment component can handle credit card transactions made by purchasers via the network or internet and/or payments to cover various expenses. The printer can print various items, including the novelty deeds discussed above (and in further detail below). In certain embodiments, the printer can be off site (e.g., the printer can include a consumer's printer receiving print commands from the server computer via a network or the internet). While a single server is shown and described for performing the functions described herein, multiple, different servers may be employed, including servers operated by third party service providers.

Referring to FIG. 3B, an alternative embodiment to the system 300 is shown as a system 350. The system 350 is substantially similar to the system 300, but includes more than one server computer (shown as server computers 1, 2, . . . J). A load balancing system 352 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 354 couples the web servers to several databases (shown as databases 1, 2, . . . K). A distributed file system is a type of file system in which the file system itself manages and transparently locates pieces of information (e.g., content pages) from remote files or databases and distributed files across the network, such as a LAN. The distributed file system also manages read and write functions to the databases.

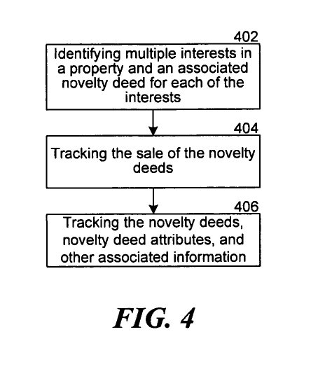

A computing environment can be used to facilitate many or all of the novelty deed functions discussed earlier with reference to FIG. 1 and provide additional capabilities. FIG. 4 is a flow chart illustrating a computer implemented method for managing novelty deeds in accordance with embodiments of the invention. For example, the computer implemented method can include identifying multiple interests of a famous property and an associated novelty deed for each of the interests (block 402), and tracking the sale of the novelty deeds (block 404). Each of the fractional property interests are a data structure stored in the database. The data structures include the information regarding each property, as described herein.

In certain embodiments, the one or more computers identify multiple interests of a famous property and an associated novelty deed for each of the interests by receiving user input with the novelty deed (representing the corresponding interest) or receiving user input with the interest and the computer creates the corresponding novelty deed. In other embodiments, identifying multiple interests of a famous property and an associated novelty deed for each of the interests can include using the computing environment to map the property into multiple interests and to create the novelty deeds for each of the interests. In still other embodiments, the computing system can identify multiple interests of a famous property and an associated novelty deed for each of the interests by selecting a novelty deed (representing an interest) from a database or selecting an interest from a database and creating a corresponding novelty deed.

Tracking the sale of the novelty deeds (block 404) can include tracking that a specific novelty deed has been sold, how many novelty deeds have been sold, or issued, how many are available for sale or issue, and/or which novelty specific deeds have been issued or available for issue. Additionally, tracking the sale of the novelty deeds (block 404) can include tracking other sale attributes. For example, tracking the sale of the novelty deeds (block 404) can include tracking the sale price and whether the sale money for a specific novelty deed transaction has been received.

As discussed above, in certain embodiments the novelty deeds can be sold for a predetermined amount of money. For example, novelty deeds representing an interest near the fifty yard line in a football stadium could be sold for a first predetermined amount and novelty deeds representing an interest near the goal lines could be sold for a second predetermined amount. In other embodiments, novelty deeds can be sold for non-predetermined amounts (e.g., sold at auction).

Also, as discussed above, in selected embodiments novelty deeds can be valid for a predetermined time and invalid after the predetermined time has expired. In certain embodiments, the computing environment can track when the predetermined time has expired and/or provide notice that the predetermined time is about to expire. For example, in selected embodiments the computer can automatically create a mailing or email to notify the owner of the corresponding novelty deed that the expiration date is near. In other embodiments, the computer can send a message to a user of the computing environment that the expiration date is near. In still other embodiments, the computer can complete an automatic repurchase or renewal of the corresponding novelty deed. For example, an owner can provide authorization so that the computer automatically charges a credit card for the price of repurchasing the novelty deed around the time the novelty deed expires (e.g., at expiration, an increment of time before expiration, or an increment of time after expiration).

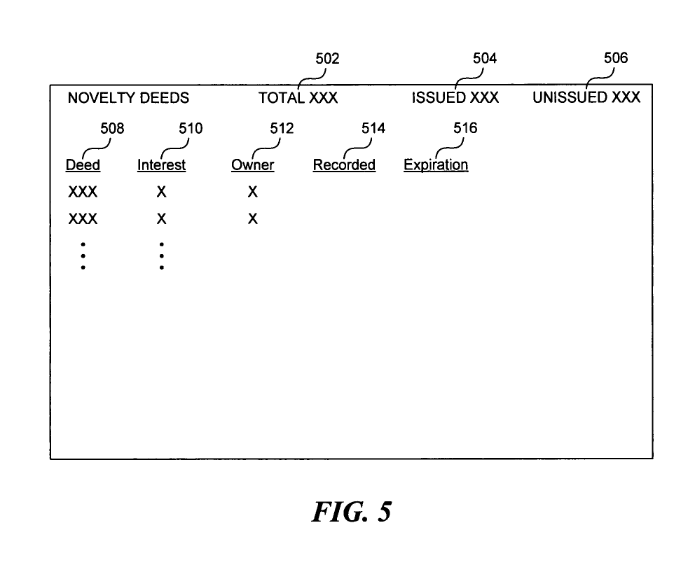

In other embodiments of the invention, a computer implemented method for managing novelty deeds can include tacking the novelty deeds, novelty deed attributes, and other associated information. For example, as illustrated in FIG. 5, the computing system can track a total number of novelty deeds 502, a number of novelty deeds that have been issued or sold 504, a number of unissued novelty deeds 506 (e.g., novelty deeds available for sale). Additionally, the computing system can track each individual novelty deed 508, a physical description or location 510 (if applicable) of the interest represented by each novelty deed, an owner of the novelty deed 512, whether each novelty deed has been recorded 514 (e.g., with a state agency), and an expiration date of each novelty deed 516 (if applicable).

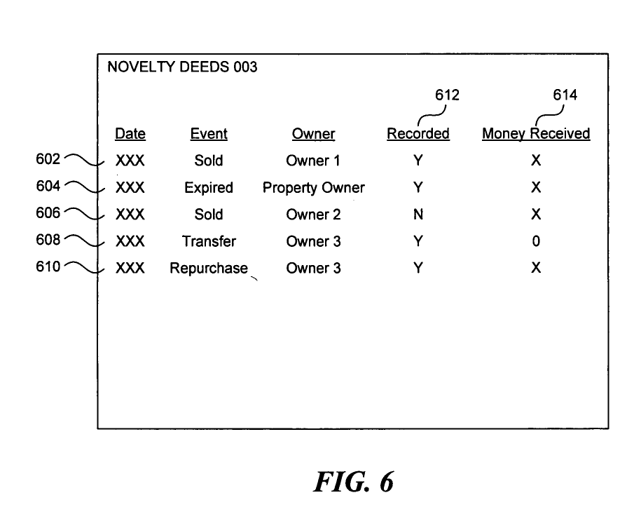

In certain embodiments the ownership of novelty deeds can be tracked in additional detail. For example, tracking ownership of novelty deeds can include tracking the current owner of a novelty deed (e.g., after a sale or transfer) and/or the ownership history of a novelty deed. FIG. 6 shows a schematic illustration of a computer screen in a computing environment that can be used to track the ownership history of a novelty deed 003 in accordance with certain embodiments of the invention. In FIG. 6, the first entry 602 shows that after the initial sale of novelty deed 003, the novelty deed is owned by Owner 1. The second entry 604 shows that a predetermined period of time has expired and the novelty deed has reverted to the Owner of the Property. Accordingly, the Owner of the Property can resale the novelty deed to another individual or entity. The third entry 606 shows that the Owner of the Property has resold the novelty deed to Owner 2. The fourth entry 608 shows that owner 2 has transferred (e.g., sold or given) the property to Owner 3. The fifth entry 610 shows that Owner 3 has repurchased the novelty deed at the expiration of a second predetermined period of time (e.g., for a third predetermined period of time). As shown in FIG. 6, other information can be tracked. For example, whether each sale/transfer of the novelty deed was recorded 612 (e.g., with a state agency) and/or the amount of money received by the Owner of the Property or a management service 614 for each transaction. For example, in the illustrated embodiment the Owner of the Property/management service did not receive any money for the transfer of novelty deed 003 between Owner 2 and Owner 3.

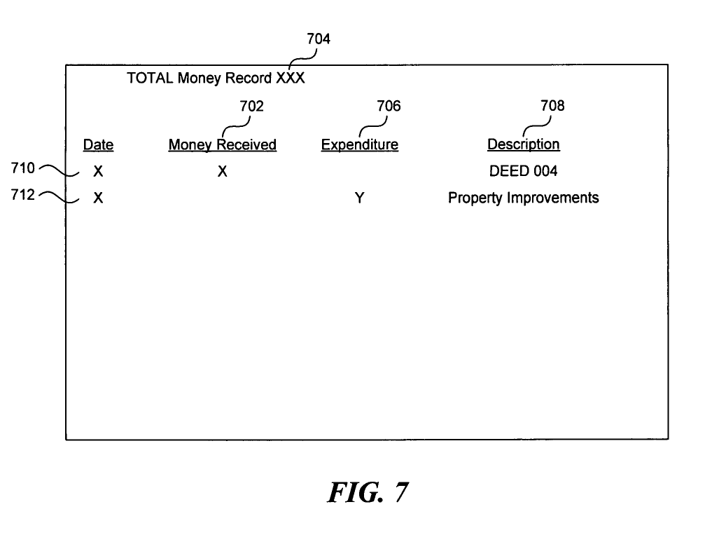

In selected embodiments, the computing system can track the use of a portion of the money received from the sale of the novelty deeds. FIG. 7 is a schematic illustration of a computer screen in a computing system that can be used to track the use of this portion of money in accordance with certain embodiments of the invention. In FIG. 7, at least a portion of the money received for the sale of novelty deeds can be recorded 702 and totaled (e.g., in the total amount 704). Expenditures against these funds can be recorded 706 and can also be subtracted from the totaled amount 704. A description can be recorded 708 to track how the funds are used. For example, the first entry 712 shows that x amount was received from the sale of novelty deed 004 and the second entry 714 shows that y amount was spent or used on property improvements. As discussed above, money received from the sale of novelty deeds can be used for various purposes, including managing the novelty deeds, acquiring the property, maintaining the property, improving the property, for a charitable purpose, and/or for other purposes at the discretion of the owner of the property. While FIGS. 5-7 are described above as suitable computer screens, each also provides a visual representation of data structures associated with novelty deeds and their management. Thus the description herein applies to user interfaces for displaying the data structure, and the data structures themselves.

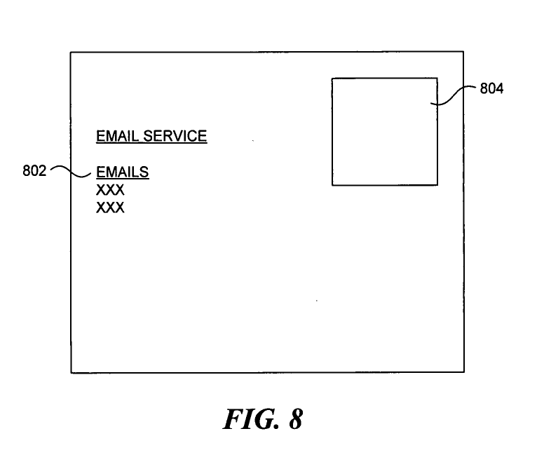

In still other embodiments, the computing system can be used to market novelty deeds, aid in marketing novelty deeds, and/or offer novelty deeds for sale. FIG. 8 is a schematic illustration of a computer screen in a computing system used to market novelty deeds and/or offer novelty deeds for sale, in accordance with embodiments of the invention. In FIG. 8, a portion of the screen provides an email service to a consumer. The computing environment can be used to send emails containing advertisements, other marketing information, and/or offers of sale to potential customers. For example, in certain embodiments the emails can be automatically generated and sent (e.g., by the mail component of the server computer shown in FIG. 3A) using a stored list and/or in response to email inquiries received by the system. In other embodiments, the emails can be generated by the computing system in response to an input from a user of the computing system. In still other embodiments, mailers can be created by the computing system (via the mail component of the server computer and the printer shown in FIG. 3A) to advertise or allow purchase (e.g., by return mail) of novelty deeds. For example, in one embodiment an insert can be generated and mailed with credit cards having a University of Southern California (USC) logo (or with the associated credit card bill) advertising (or offering to sell) novelty deeds representing a portion of the USC stadium.

In still other embodiments, the computing system can place advertisements on various websites 804 and/or provide a dedicated website (e.g., available via a web search or via a link form other websites) for providing marketing information to perspective customers and/or to allow consumers to purchase novelty deeds. For example, in certain embodiments the website 804 includes an offer for sale of a novelty deed and a data field where a consumer can enter a credit card number to pay for the novelty deed. The transaction can be processed by the payment component of the server computer shown in FIG. 3A. In other embodiments, the website 804 can contain information regarding various stores that sell novelty deeds. In still other embodiments, the website can include one or more menus with various categories that have associated novelty deeds for sale. For example, in certain embodiments the categories can include sports and landmarks. If a consumer selects landmarks a list of landmarks having novelty deeds for sale can be displayed (e.g., the Grand Canyon and the Statue of Liberty). If the consumer selects sports, a submenu can be displayed, for example, containing baseball, football, horseracing, and NASCAR. If football is selected, an additional submenu can be displayed (e.g., containing NFL and Collegiate). If NFL is selected, a list of NFL properties that have novelty deeds for sale can be displayed. Once a property is selected, a website allowing the consumer to select and purchase a corresponding novelty deed can be displayed. In other embodiments, the website 804 can include other information or data related to the novelty deeds, including pictures of at least a portion of the property, the location of various novelty deeds, pictures of people associated with the novelty deeds, etc.

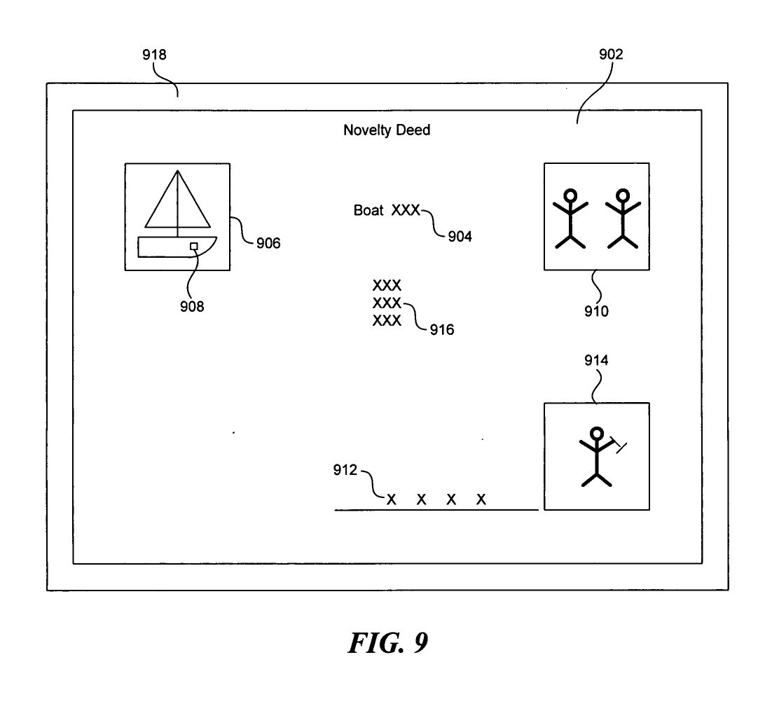

FIG. 9 is a schematic illustration of a tangible document 902 representing or corresponding to a novelty deeds (e.g., a novelty deed itself or a certificate representing a novelty deed) in accordance with embodiments of the invention. For example, the printer shown in FIG. 3A can be used to print the document. In certain embodiments, the document can include the name of the property 904, a picture of the property 906, a graphic representation of the location of the associated interest 908, a picture of people associated with the property 910 (e.g., famous people), an autograph of a person associated with the property 912 (e.g., a famous person), and/or a picture of the person signing the novelty deed 914. In other embodiments, the document 902 can have more, fewer, and/or different features. Additionally, in selected embodiments the document 902 can be placed in a frame 918 and/or can be laminated (e.g., for an additional fee). In certain embodiments where a novelty deed is mailed to a consumer/purchaser, a return mailer can be included with the novelty deed to facilitate additional purchases (e.g., having the novelty deed framed or for the purchase of additional novelty deeds). In other embodiments, the server computer (shown in FIG. 3A) can allow the consumer/buyer to print the document 902 on the consumer's computer via the internet once the corresponding novelty deed is purchased.

A feature of some of the embodiments discussed above is that by managing novelty deeds (e.g., selling novelty deeds), owners or potential owners of property can generate income. In some cases, this income can be used to perform maintenance and upkeep of the property, for the benefit of the owner, and/or for the benefit of the public. Accordingly, in some situations this income can allow the owner to perform maintenance and/or make improvements to the property without having to raise admission/use fees, or in the case where the owner is a government agency without collecting additional taxes.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number respectively.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the telecommunication system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

While certain aspects of the invention are presented below in certain claim forms, the inventors contemplate the various aspects of the invention in any number of claim forms. For example, while only one aspect of the invention is recited as a means for performing a function, other aspects may likewise be embodied as a means for performing a function. Accordingly, the inventors reserve the right to add additional claims after filing the application to pursue such additional claim forms for other aspects of the invention.

I/We claim:

1. A data processing system for managing rights, the system comprising:
means for defining fractional interests in a property, wherein the means for defining obtains data associated with a division of the property, wherein the data associated with the division corresponds to surveying or mapping the property to divide the property into multiple interests;
means for creating a novelty deed for each of the interests; and
means for distributing the novelty deeds to individual entities for a predetermined amount of money as a souvenir of the property.

2. The data processing system of claim 1 wherein the novelty deeds do not convey an actual ownership right in the corresponding interests or the novelty deeds convey an actual ownership right in the corresponding interests, but without legal obligations associated therewith.

3. The data processing system of claim 1, further comprising means for terminating the novelty deeds after a predetermined time frame.

4. The data processing system of claim 1, further comprising:
means for processing the sale of the novelty deeds; and
means for associating a portion of the money received from the sale for at least one of managing the novelty deeds, acquiring the property, maintaining the property, improving the property, and a charitable purpose.

5. A method for generating income for a famous property comprising:
dividing the famous property into multiple interests, the famous property being located on or in earth;
creating a novelty deed for each of the interests;
selling novelty deeds to consumers;
creating a tangible novelty deed document corresponding to each novelty deed sold; and
distributing the tangible novelty deed documents to the corresponding consumers.

6. The method of claim 5, further comprising at least one of surveying and mapping the property to divide the property into multiple interests.

7. The method of claim 5 wherein the novelty deeds do not convey actual ownership rights in the corresponding interests or the novelty deeds convey actual ownership right in the corresponding interests.

8. The method of claim 5 wherein selling novelty deeds to consumers includes selling novelty deeds for one or more predetermined amounts of money.

9. The method of claim 5 wherein the novelty deeds are valid for a predetermined time frame and invalid after the expiration of the predetermined time frame.

10. The method of claim 5, further comprising tracking ownership of the novelty deeds.

11. The method if claim 5 wherein the property includes at least one of real property, personal property, tangible property, and intangible property.

12. The method of claim 5, further comprising:
receiving the money from the sale of the novelty deeds; and
using a portion of the money received from the sale for at least one of managing the novelty deeds, acquiring the property, maintaining the property, and improving the property.

13. The method of claim 5, further comprising:
receiving the money from the sale of the novelty deeds; and
using a portion of the money received from the sale for a charitable purpose.

14. The method of claim 5 wherein ownership of one or more novelty deeds does not convey an actual ownership right to the associated interest, but does convey a privilege with regard to the property.

15. A method for generating income for a famous property comprising:
dividing the famous property into multiple interests, the famous property being located on or in earth;
creating a novelty deed for each of the interests; and
selling the novelty deeds to consumers, wherein the novelty deeds are valid for a predetermined time and invalid after the predetermined time has expired.

16. The method of claim 15 wherein a novelty deed can be resold or renewed after the predetermined period has expired.

17. The method of claim 15 wherein the novelty deeds do not convey actual ownership rights in the corresponding interests or the novelty deeds convey actual ownership right in the corresponding interests.

18. The method of claim 15, further comprising tracking the validity of each novelty deed.

19. The method of claim 15, further comprising:
receiving the money from the sale of the novelty deeds; and
using a portion of the money received from the sale for at least one of managing the novelty deeds, acquiring the property, maintaining the property, improving the property, and a charitable purpose.

20. The method of claim 15, further comprising tracking ownership of the novelty deeds.
